(19) United States
(12) Patent Application Publication
(10) Pub. No.: US 2014/0267981 A1
(43) Pub. Date: Sep. 18, 2014

(54) BACKLIGHT MODULE AND LIQUID CRYSTAL DISPLAY DEVICE HAVING THE SAME

(71) Applicant: SUNHENG TECHNOLOGY CO., LTD., Taichung City (TW)

(72) Inventor: Barry LEE, Taichung City (TW)

(73) Assignee: SUNHENG TECHNOLOGY CO., LTD., Taichung City (TW)

(21) Appl. No.: 13/796,104

(22) Filed: Mar. 12, 2013

(51) Int. Cl. F21V 8/00

(52) U.S. Cl. CPC G02B 6/0021; G02B 6/0015
USPC 349/65; 362/607

(57) ABSTRACT

A backlight module and a liquid crystal display device having the same are provided. The backlight module includes a light guide plate, a light source, a shading sheet and at least one reflecting sheet. The light guide plate has a first face, a second face corresponding to the first face and a lateral face connected to the first face and the second face, and a light gathering structure is formed at least on the first face. The light source includes a light emitting device and two power source legs, and the light emitting device is detachably attached to the light guide plate. The shading sheet is attached to the first face. The at least one reflecting sheet is attached to the lateral face.

### BACKGROUND OF THE INVENTION

1. Field of the Invention

The present invention relates to a backlight module and a liquid crystal display device having the same.

2. Description of the Prior Art

A backlight module is used mainly to provide light to a liquid crystal display device, and so is the backlight module of a torque tool. The inventor developed a light gathering structure for a backlight module of a torque tool before and sought to protect the invention by filing a patent application which had granted as TWM405341. In TWM405341, although the backlight module can avoid the waste of the light which emits out from the bottom and lateral faces via using the shading sheet attached to the bottom face and the electroconductive rubber attached to the lateral face of the light guide plate, so that the light can be gathered to emit out mainly from the top face, for achieving the displaying effect of the liquid crystal display.

Although the structure of TWM405341 can reduce the waste of the light and has good effect of gathering light, the inventor has been not satisfied and kept researching and developing in the light gathering structure for a backlight module, and it was found that the above light gathering structure of the backlight module has deficiency in gathering light. Besides, via the structure in TWM405341, the liquid crystal display device has dark areas at edges and corners thereof as the light passes through the light guide plate, thus causing non-uniform brightness of the liquid crystal display device.

Furthermore, since the LED of the light source is fixedly disposed in the light guide plate, both of the LED and the light guide plate have to be changed as the LED is broken down or damaged. However, raw materials are now very expensive, it causes a high cost for the discarding of both the LED and the light guide plate just due to one part of the backlight module is broken down or damaged. Additionally, the discarded parts will cause problems of a huge amount of garbage and classification of the discarded parts, and it is not eco-friendly.

The present invention is, therefore, arisen to obviate or at least mitigate the above mentioned disadvantages.

### SUMMARY OF THE INVENTION

An object of the present invention is to provide a backlight module and a liquid crystal display device having the same which can effectively gather light.

Another object of the present invention is to provide a backlight module and a liquid crystal display device having the same which can be easy to change, repair and eco-friendly.

To achieve the above and other objects, a backlight module includes a light guide plate, a light source, a shading sheet and at least one reflecting sheet. The light guide plate has a first face, a second face corresponding to the first face and a lateral face connected to the first face and the second face, and a light gathering structure is formed at least partially on the first face. The light source includes a light emitting device and two power source legs, and the light emitting device is detachably attached to the light guide plate. The shading sheet is attached to the first face. The at least one reflecting sheet is attached to the lateral face.

To achieve the above and other objects, a liquid crystal display device includes one of the above backlight module, a liquid crystal display and a control circuit board. The liquid crystal display is disposed on the second face, the control circuit board is disposed on the first face, and the shading sheet is located between the control circuit board and the first face.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are breakdown drawings of a backlight module according to a preferred embodiment of the present invention;

FIG. 2A is a partial enlargement of FIG. 2;

FIG. 3 is a view showing a backlight module applied to a liquid crystal display device according to a preferred embodiment of the present invention;

FIG. 3A is a partial enlargement of FIG. 3; and

FIG. 4 is a perspective view showing a backlight module applied to a liquid crystal display device according to a preferred embodiment of the present invention.

### DETAILED DESCRIPTION OF THE PREFERRED EMBODIMENTS

As shown in FIGS. 1 and 2, a backlight module according to a preferred embodiment of the present invention includes a light guide plate 1, a light source 2, a shading sheet 3 and a reflecting sheet 4.

The light guide plate 1 has a first face 11, a second face 12 corresponding to the first face 11 and a lateral face perpendicularly connected to edges of the first face and the second face. A light gathering structure 13 is formed at least partially on the first face 11 of the light guide plate 1, and the first face 11 is formed with an assembly hole 14. The light gathering structure 13 includes a plurality of microstructure 131 which are substantially circular as shown in FIG. 2A (however, may be polygonal such as triangular or diamond, tooth-shaped, or in other geometrical form). Each microstructure 131 includes a concave pattern which is concaved from the first face 11 toward the second face 12 with a predetermined depth. Preferably, the microstructures 131 are substantially equidistantally and regularly arranged on the first face 11; however, the microstructures 131 may be not equidistantally and regularly arranged. Two positioning ribs protrude from the second face at one end of the second face and correspond to the assembly hole. The assembly hole 14 may be a blind hole or through hole.

The light source 2 is detachably attached to the light guide plate. In this embodiment, the light source 2 is detachably attached to the light guide plate 1 from the first face 11. More specifically, the light source 2 is detachably disposed in the assembly hole 14 which is formed at one end of the light guide plate 1 near the gathering structure. The disposal of the light source 2 may be, for example, tight fit, hooking or adhesion. The light source 2 is disposed near one end of the light guide plate 1, and the light source 2 includes a light emitting device 21 and a plurality of power source leg 22. In this embodiment, the light emitting device 21 is a LED device which is disposed within the assembly hole of the light guide plate 1. Each power source leg 22 is electrically connected to the light emitting device 21 and protrusive outside the first face 11 of the light guide plate 1. Preferably, the assembly hole 14 may have two slots extending from the first face 11 toward the second face 12, and each slot has a opening width equal to or slightly smaller than the thickness of the light source 2 so that the light source 2 can be tightly fitted into the slots without any additional member or combination material such as adhesive.

Preferably, a side surface 140 in the assembly hole 14 includes a first region 141 facing the light emitting device 21, and the first region 141 is formed with a light diffusing structure 142. The light diffusing structure 142 may, for example, include parallel prisms or other geometrical structures. The light diffusing structure 142 can evenly distribute the light from the light emitting device 21 inside the light guide plate 1 to provide good uniformity of the backlight module. More preferably, the side surface 140 further includes a second region 143 which is connected to the first region 141, and a light collecting structure 144 is disposed at least partially on the second region 143. As shown in FIGS. 3, 3A and 4, in this embodiment, the first region 141 is defined as a frontal surface relative to the light emitting device 21, and the second region 143 includes two side surfaces located respectively on two sides of the frontal surface and a top surface connected to the frontal surface and the two side surfaces. The light collecting structure 144 is disposed on the two side surfaces and the top surface, in which the light collecting structure 144 can reflect and collect the light from the light emitting device 21 and effectively guide the light to come inside the light guide plate 1 via the frontal surface, so that the light is more efficiently used and the brightness is improved. It is noted that the light collecting structure 144 may be detachably attached to (such as adhered to or coated on) or integrally form with the second region 143.

The shading sheet 3 is attached to the first face 11 of the light guide plate 1 (by adhering, for example). The shading sheet 3 can block the light emitting out from the light guide plate 1 and reflect the light back into the light guide plate 1, thus enhancing the efficiency of the use of the light and avoiding the waste of the light. Additionally, a light-uniforming sheet 3a may be attached to the second face 12 of the light guide plate 1, so as to uniform and gentle the light source.

The reflecting sheet 4 is encompassed around the entire lateral side faces of the light guide plate 1 (by adhering, for example). Preferably, the reflecting sheet 4 adhered to the entire lateral side faces of the light guide plate 1; however, a reflecting element may be entwined around the entire lateral side faces of the light guide plate 1. The reflecting sheet 4 can reflect the light emitting toward the lateral side faces of the light guide plate 1 back into the light guide plate 1, thus enhancing the efficiency of the use of the light, more effectively gathering the light and avoiding the waste of the light.

As the backlight module is applied to a liquid crystal display device, as shown in FIGS. 3 and 4, the liquid crystal display device includes one of the above backlight module and further includes a liquid crystal display 5 and a control circuit board 6. The liquid crystal display 5 is disposed on the second face 12 of the light guide plate 1 and aligned with the light guide plate via the ribs on the second face. The control circuit board 6 is disposed on the first face 11 of the light guide plate 1, and the shading sheet 3 is located between the control circuit board 6 and the first face 11.

As the light from the light source 2 comes into the light guide plate 1, the light is blocked by the shading sheet 3 and the reflecting sheet 4 so that the light is not permitted to emit out form the first face and the lateral faces of the light guide plate, and the light can be substantially entirely gathered within the light guide plate. The effectively-gathered light within the light guide plate is then refracted by the regular or irregular microstructures (or micro-teeth) on the first face 11 (as shown in FIG. 2) to provide excellent light gathering and emitting effects. Also, the plurality of light gathering structures may cooperate with the light-uniforming sheet on the second face so as to uniform and gentle the emitted light (the emitted light will be not harsh to the eye), thus facilitating the recognition of the liquid crystal display 5.

Furthermore, in the backlight module of the present invention, since the light source 2 and the light guide plate may be detachable relative to each other, it needs to replace the broken-down or damaged light source in the assembly hole 14 of the light guide plate by a new light source, and the backlight module can work. As such, the user can continue using the light guide plate, and need not discard the non-damaged light guide plate so that useful parts will not be wasted. Besides, the problems of huge amount of garbage, classification of the discarded parts and high cost can be avoided. More important, since the light source 2 and the light guide plate may be detachable relative to each other, it needs to purchase only one element which is broken-down so that the much cost can be saved.

Moreover, since the structure of the backlight module is simple, the backlight module can be applied to a small-sized device and designed according to various control circuit boards with different dimensions.

Given the above, the backlight module of the present invention can effectively gather and uniform light so as to enhance the luminance or brightness of the liquid crystal display, and can be easy to change, repair and eco-friendly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A backlight module, including:
a light guide plate, having a first face, a second face corresponding to the first face and a lateral face connected to the first face and the second face, and a light gathering structure being formed at least partially on the first face;
a light source, including a light emitting device and two power source legs, the light emitting device being detachably attached to the light guide plate;
a shading sheet, attached to the first face; and
at least one reflecting sheet, attached to the lateral face.

2. The backlight module of claim 1, wherein the first face is formed with an assembly hole, and the light source is detachably disposed in the assembly hole.

3. The backlight module of claim 2, wherein the light gathering structure includes a plurality of microstructures substantially in geometrical form.

4. The backlight module of claim 3, wherein the microstructures are substantially equidistantally arranged on the first face.

5. The backlight module of claim 4, further including a light-uniforming sheet attached to the second face.

6. The backlight module of claim 5, wherein the light gathering structure is arranged partially on the first face, and the assembly hole is formed at one end of the light guide plate near the gathering structure.

7. The backlight module of claim 2, wherein a side surface in the assembly hole includes a first region facing the light emitting device, and the first region is formed with a light diffusing structure.

8. The backlight module of claim 7, wherein the side surface further includes a second region which is connected to the first region, and a light collecting structure is disposed at least partially on the second region.

9. A liquid crystal display device, including one of the backlight module of claim 1, further including a liquid crystal display and a control circuit board, the liquid crystal display being disposed on the second face, the control circuit board being disposed on the first face, and the shading sheet being located between the control circuit board and the first face.
